(19) United States
(12) Patent Application Publication
(10) Pub. No.: US 2026/0230214 A1
(43) Pub. Date: Aug. 6, 2026

(54) GNSR-AWARE SPECTRAL SLOT ASSIGNMENT WITH WAVELENGTH CONVERTERS

(71) Applicant: 1FINITY Inc., Kawasaki-shi (JP)

(72) Inventors: Inwoong KIM, Allen, TX (US); Paparao PALACHARLA, Richardson, TX (US)

(73) Assignee: 1FINITY Inc., Kawasaki-shi (JP)

(21) Appl. No.: 19/043,215

(22) Filed: Jan. 31, 2025

(51) Int. Cl. H04J 14/02; H04B 10/079

(52) U.S. Cl. CPC H04J 14/02762; H04B 10/0795

(57) ABSTRACT

According to an aspect of an embodiment, operations may include receiving a wavelength demand for transmitting optical signals in required wavelength ranges. The operations may also include identifying an optical path that includes a plurality of nodes. In addition, the operations may include, for each individual node of the plurality of nodes, grouping one or more virtual nodes into a first group and a second group. The operations may also include identifying a plurality of spectral paths of the optical path. The operations may further include iterating each respective virtual node along the plurality of spectral paths to identify a list of candidate spectral paths in the plurality of spectral paths for each virtual node. In addition, the operations may further include serving the wavelength demand when all virtual nodes are iterated and at least one spectral path of the plurality of spectral paths remains after iteration.

### FIELD

The embodiments discussed herein are related to assigning spectral slots in an optical network.

### BACKGROUND

Telecommunications systems, cable television systems and data communication networks use optical networks to convey information between remote points. In an optical network, information is conveyed in the form of optical signals through optical fibers or other optical media. The optical networks may include various components such as amplifiers, dispersion compensators, multiplexer/demultiplexer filters, wavelength selective switches, couplers, etc. configured to perform various operations within the optical network.

Due to the varying levels of noise introduced by different optical components and fibers, selecting an optimal network path for a communication request is essential for an optical network. The optimal path may be selected by minimizing network cost and maximizing performance to ensure efficient signal transmission across the network.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, operations may include receiving a wavelength demand for transmitting optical signals in required wavelength ranges. The operations may also include identifying an optical path that includes a plurality of nodes. Each node of the plurality of nodes respectively includes a plurality of available spectral slots for propagation of the optical signals in respective corresponding wavelength ranges. The optical signal or wavelength may occupy multiple spectral slots depending on optical signal bandwidth in flexible grid optical networks. In addition, the operations may include, for each individual node of the plurality of nodes, grouping one or more first virtual nodes that respectively correspond to a virtual source node or individual potential incoming spectral slots of the individual node into a first group, and grouping one or more second virtual nodes that respectively correspond to a virtual destination node or individual outgoing spectral slots of the individual node into a second group. The operations may also include identifying a plurality of spectral paths of the optical path. The plurality of spectral paths is individually related to propagation of the optical signals in one or more spectral slots associated therewith. Each spectral path of the plurality of spectral paths passes through one of a plurality of virtual nodes in each first group and each second group of each individual node. The operations may further include iterating each respective virtual node along the plurality of spectral paths to identify a list of candidate spectral paths in the plurality of spectral paths for each virtual node. Each candidate spectral path of each respective virtual node connects the respective virtual node being iterated to a virtual node corresponding to a next group of virtual nodes along the optical path. The iterating of the respective virtual nodes including pruning one or more candidate spectral paths based on one or more GSNR (Generalized Signal to Noise Ratio) factors. In addition, the operations may further include serving the wavelength demand when all virtual nodes are iterated and at least one spectral path of the plurality of spectral paths remains after iteration.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example embodiment of a spectral slot assignment module configured to assign spectral slots in an optical network;

FIG. 2 illustrates a block diagram of an example computing system that may be used to determine a power profile estimation;

FIG. 3 illustrates the process of creating an auxiliary graph at the source and destination nodes of an optical path;

FIG. 4 illustrates the process of creating an auxiliary graph at an intermediate node of an optical path;

FIG. 5 illustrates the calculation of costs for different segments within a spectral path;

FIG. 6 illustrates an example of assessing the costs associated with candidate spectral paths;

FIG. 7 illustrates an example of assessing various costs of candidate spectral paths at an intermediate node;

FIG. 8 illustrates a pruning process for candidate spectral paths based on their cost ranges and additional factors;

FIG. 9 is a flowchart of an example method for processing a wavelength demand in an optical network; and

FIG. 10 is a flowchart of an example method for assigning spectral slots in an auxiliary graph.

### DESCRIPTION OF EMBODIMENTS

In optical networks, selecting the optimal link between nodes from multiple candidates is important for ensuring high performance, reliability, and cost-efficiency. One of the factors considered in this selection process is the cost associated with different links. In some instances, link cost may be defined as the inverse of the Signal-to-Noise Ratio (SNR), with higher SNR values indicating better signal quality due to less degradation from noise across the optical path. Noise in optical links typically includes both linear and nonlinear noises. Linear noise may include noises from Amplified Spontaneous Emission (ASE), while nonlinear noise often originates from transmission media, including fibers. In this disclosure, the term “generalized” SNR (GSNR) is used to refer to both linear and nonlinear noise effects within an optical link. GSNR margin refers to the difference between the GSNR of a given path (from source to destination node) and a required GSNR threshold (RGSNR_{threshold}) for a communication request.

This disclosure illustrates various systems and methods that may be used for identifying an “optimal” link among multiple optical paths in an optical network. When selecting the optimal link from candidate options, links with relatively low GSNR margins may be prioritized (e.g., the links with the lowest GSNR margins) to better utilize channel capacity and reduce and/or minimize resource waste. In instances in which multiple links share the same GSNR margin or have GSNR margins within a certain range of each other, other factors, such as number of wavelength converters and wavelength cost, may also be considered in the selection process. In the present disclosure, reference to an “optimal” link may refer to a link that is selected based on the optimization techniques and/or goals that are discussed herein. However, it is understood that a link that is referred to as the “optimal” link may not necessarily be the absolute best link that may be used.

Embodiments of the present disclosure will be explained with reference to the accompanying drawings.

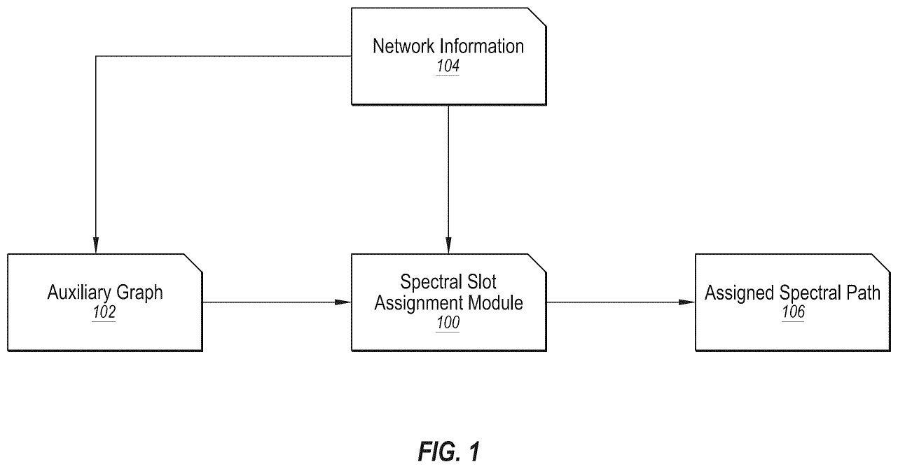

FIG. 1 illustrates an example embodiment of a spectral slot assignment module 100 configured to assign spectral slots in an optical network, arranged in accordance with at least some embodiments of the present disclosure. A spectral slot (or “slot”) refers to a specific segment of the optical spectrum that is allocated for transmitting data. When a network device initiates new traffic transmission from a source node to a destination node in an optical network, it generates a new wavelength demand specifying the required wavelength ranges for that traffic. Upon receiving this demand, a network controller collects information about the optical network and chooses an optical path using network routing algorithms such as shortest path search or K shortest path search. An optical path is a physical connection from the source node to the destination node through one or more intermediate nodes. All nodes involved in this path, the source node, the intermediate nodes, and the destination node, are physical nodes in the network. These nodes are connected by fiber links. An optical path comprises multiple fiber links that sequentially connect one physical node to the next.

The spectral slot assignment module 100 (“module 100”) may be included in any suitable device in the optical network such as control plane computing systems or network controllers. For example, module 100 may be included in optical cross-connects (OXCs), reconfigurable optical add-drop multiplexers (ROADMs), or Software-Defined Networking (SDN) controllers. A network controller may also include a PCE (Path Calculation Element) in the optical network. Although this disclosure primarily describes spectral slot assignment as being performed by a network controller, it should be understood that module 100 is not limited to being implemented only in network controllers. Module 100 may be implemented in any appropriate network device within the optical network.

The network information 104 represents various aspects of the optical network, such as spectral occupancies, supported bands, and the status of available wavelength converters, etc. The network information 104 may be collected by any suitable network monitoring devices in the optical network, such as a network controller. The collected network information may include details about the physical nodes, such as available ROADMs, OXCs, optical amplifiers, regenerators, wavelength converters, transponders, or any other available network devices. The collected network information may also include available fiber links connecting the physical nodes, supported optical bands, the distribution of available spectral slots, available wavelength converters, available transponders, or available intermediate nodes, etc.

Based on the collected network information 104, a network controller chooses an optical path from source to destination using network routing algorithms such as shortest path search or K shortest path search. After choosing an optical path, the network controller creates auxiliary graph 102 to assign available spectral paths within the optical path. A spectral path corresponds to a potential signal path from the source node to the destination node in an optical path. Because there are multiple physical nodes and fiber links in an optical path, depending on the available transmission bands and spectral capacities of the physical nodes and fiber links, there may be multiple spectral paths in an optical path. A spectral path may include multiple wavelength ranges that respectively correspond to different segments of an optical path. A spectral path may also include various spectral slots and optional wavelength converters.

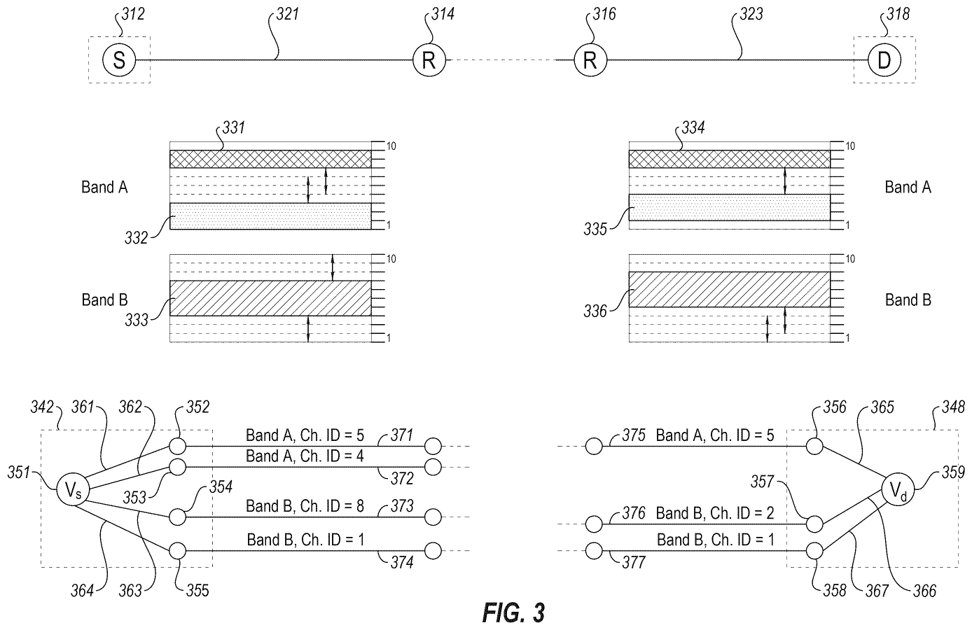

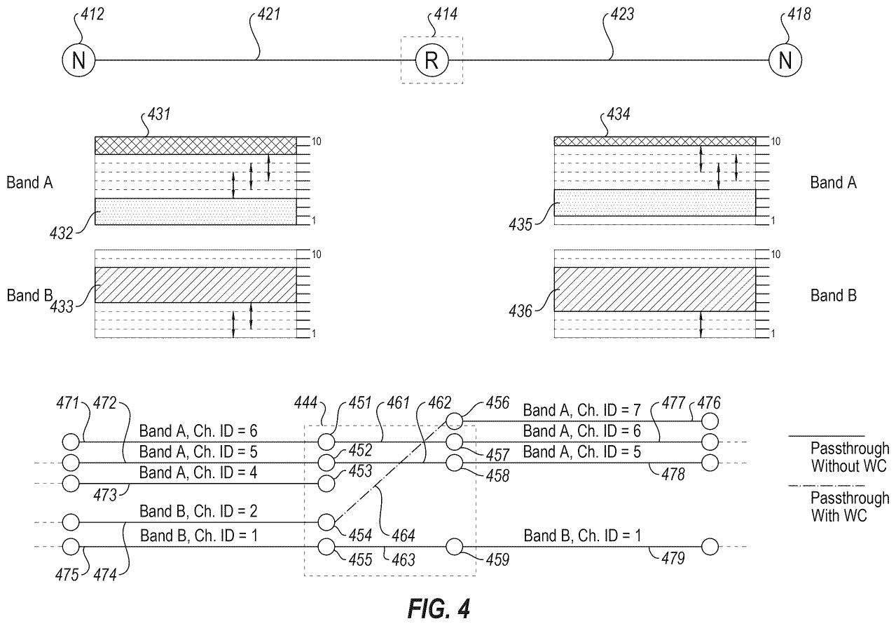

The auxiliary graph 102 represents various available spectral paths from a source node to a destination node in the optical network. The auxiliary graph 102 may be generated based on collected network information 104 and a chosen optical path. In some embodiments, the auxiliary graph 102 may be generated such as described with respect to FIGS. 3 and 4 of the present disclosure.

Based on the auxiliary graph 102 and the network information 104, the module 100 applies a spectral slot assignment algorithm to determine an optimal spectral path. The module 100 assigns a spectral path among the various paths in the auxiliary graph 102 that will meet required GSNR threshold (RGSNR_{threshold}) with minimum GSNR margin. Assigned spectral path 106 is the output from the module 100 based on the auxiliary graph 102 and the network information 104. For example, in some embodiments, the module 100 may be configured to perform one or more operations described with respect to FIGS. 3-10 to determine the optimal spectral path.

Modifications, additions, or omissions may be made to FIG. 1 without departing from the scope of the present disclosure. For example, the specific properties and/or operations described may vary.

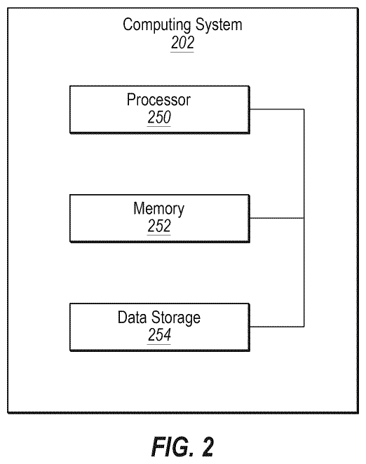

FIG. 2 illustrates a block diagram of an example computing system 202 that may be used to assign spectral slots in an optical network, according to at least one embodiment of the present disclosure. The computing system 202 may be configured to implement or direct one or more operations associated with the module 100 of FIG. 1, in some embodiments.

The computing system 202 may include a processor 250, a memory 252, and a data storage 254. The processor 250, the memory 252, and the data storage 254 may be communicatively coupled.

In general, the processor 250 may include any suitable special-purpose or general-purpose computer, computing entity, or processing device including various computer hardware or software modules and may be configured to execute instructions stored on any applicable computer-readable storage media. For example, the processor 250 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 250 may include any number of processors configured to, individually or collectively, perform or direct performance of any number of operations described in the present disclosure. Additionally, one or more of the processors may be present on one or more different electronic devices, such as different servers.

In some embodiments, the processor 250 may be configured to interpret and/or execute program instructions and/or process data stored in the memory 252, the data storage 254, or the memory 252 and the data storage 254. In some embodiments, the processor 250 may fetch program instructions from the data storage 254 and load the program instructions in the memory 252. After the program instructions are loaded into memory 252, the processor 250 may execute the program instructions.

For example, in some embodiments, the data storage 254 may include the module 100 of FIG. 1 as program instructions. The processor 250 may fetch the program instructions of the module 100 from the data storage 254 and may load the program instructions of the module 100 in the memory 252. After the program instructions of the module 100 are loaded into memory 252, the processor 250 may execute the program instructions such that the computing system 202 may implement the operations (e.g., perform the operations and/or cause performance of the operations) associated with the module 100 as directed by the instructions.

The memory 252 and the data storage 254 may include computer-readable storage media for carrying or having computer-executable instructions or data structures stored thereon. Such computer-readable storage media may include any available media that may be accessed by a general-purpose or special-purpose computer, such as the processor 250. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 250 to perform a certain operation or group of operations.

Modifications, additions, or omissions may be made to the computing system 202 without departing from the scope of the present disclosure. For example, in some embodiments, the computing system 202 may include any number of other components that may not be explicitly illustrated or described.

FIG. 3 illustrates the process of creating an auxiliary graph at the source and destination nodes of an optical path, according to at least one embodiment described in the present disclosure. The top section of FIG. 3 illustrates a chosen optical path connecting several physical nodes in the network, specifically from source node 312, intermediate ROADM nodes 314 and 316, and destination node 318. While only two intermediate ROADM nodes are illustrated here, it should be understood that an optical path may include more than two intermediate nodes or, in certain embodiments, only a single or no intermediate node. In this example, the first fiber link 321 connects the source node 312 to the initial ROADM node 314, and the last fiber link 323 connects the final ROADM node 316 to the destination node 318.

The middle section of FIG. 3 illustrates multiple transmission bands on the first and last fiber links. In this example, first fiber link 321 supports two transmission bands, labeled Band A and Band B, which may represent any of C-band, L-band, S-band, or any other optical bands. Each band is divided into 10 spectral slots, identified by their slot IDs ranging from 1 to 10. Three preexisting wavelength bars (331, 332, and 333) have already occupied certain continuous slots within Band A and Band B on the first fiber link 331. For example, wavelength bar 331 occupies slots 8-9 in Band A, wavelength bar 332 occupies slots 1-3 in Band A, and wavelength bar 333 occupies slots 4-7 in Band B. Similarly, the last fiber link 323 also supports Band A and Band B. However, the specific slots occupied by the preexisting wavelength bars differ. For example, in the last fiber link 323, wavelength bar 334 occupies slots 8-9 in Band A, wavelength bar 335 occupies slots 2-4 in Band A, and wavelength bar 336 occupies slots 5-8 in Band B.

It should be noted that, in other embodiments, a fiber link may support one or more than two transmission bands. The number of slots within each band may vary, and each band may contain a different number of preexisting wavelength bars.

The bottom section of FIG. 3 illustrates an auxiliary graph illustrating available spectral slots at the source and destination nodes. An auxiliary graph is created based on n chosen optical path. In an auxiliary graph, each physical node in the optical path is represented by two columns of virtual nodes. Virtual nodes in the left column correspond to available spectral slots in the upstream fiber link connected to the physical node. Virtual nodes in the right column correspond to available spectral slots in the downstream fiber link connected to the physical node. At the source node, since there are no upstream nodes, there is only one virtual node in the left column, referred to as the virtual source node. Likewise, there is only one virtual node in the right column of the destination node, referred to as the virtual destination node. Virtual nodes at the source or destination nodes represent spectral slots assigned for the transponders. A virtual link (e.g., virtual links 361-367 and 371-377) connects two virtual nodes to represent a potential signal path between the two.

In this example, box 342 represents the source node 312. Within box 342, the left column contains a single virtual node, labeled as virtual source node 351, while the right column includes virtual nodes 352-355. Each virtual node in the right column represents an available channel in the downstream fiber link 321. A channel may include a group of continuous spectral slots. An available channel is determined based on the continuous spectral slots available in an upstream or downstream fiber link that meets the requirements of a specified modulation format and optical signal bandwidth in the new wavelength demand. In this example, assuming that a required modulation format requires 3 continuous slots, there would be 4 channels available in fiber link 321 that may meet the demand.

To illustrate this, referring again to the middle section of FIG. 3, the available channels in fiber link 321 are represented by slots 4-6 and slots 5-7 of Band A, and slots 1-3 and slots 8-10 of Band B. The lowest slot ID in the group of slots is assigned to represent the channel. For example, Channel ID 5 is assigned to represent slots 5-7 of Band A, which is an available channel in fiber link 321 capable of meeting the new wavelength demand that requires 3 spectral slots. Accordingly, virtual node 352 is assigned Band A Channel ID 5. In a similar manner, virtual nodes 353, 354, and 355 are assigned Band A Channel ID 4, Band B Channel ID 8, and Band B Channel ID 1, respectively. Accordingly, virtual links 361-364 are added between the virtual source node 351 and the virtual nodes 352-355, respectively, as shown in the FIG. 3. Furthermore, virtual links 371-374 are respectively added between the virtual nodes (352-355) at the source node and the corresponding downstream virtual nodes in intermediate node 314.

Following the same assignment method, virtual nodes and their associated channels at the destination of the auxiliary graph may also be assigned. In this example, box 348 represents the destination node 318. Within box 348, the right column contains the virtual destination node 359. The left column includes virtual nodes 356-358, each representing an available channel in the upstream fiber link 323. Based on the available spectral slots of fiber link 323 illustrated in the middle section of FIG. 3, virtual nodes 356, 357, and 358 are assigned Band A Channel ID 5, Band B Channel ID 2 and Band B Channel ID 1, respectively. In addition, virtual links 365-367 are added between the virtual destination node 359 and the virtual nodes 356-368, respectively, as shown in the FIG. 3. Furthermore, virtual links 375-377 are respectively added between the virtual nodes 356-358 at the destination node and the corresponding upstream virtual nodes in intermediate node 316.

FIG. 4 illustrates the process of creating an auxiliary graph at an intermediate node of an optical path, according to at least one embodiment described in the present disclosure. The top section of FIG. 4 illustrates an intermediate ROADM node 414 in the chosen optical path. Physical node 412 could represent another upstream intermediate node or the source node 312. Physical node 418 could represent another downstream intermediate node or the destination node 318. The upstream fiber link 421 connects the physical node 412 to the intermediate ROADM node 414, while the downstream fiber link 423 connects the intermediate ROADM node 414 to the downstream physical node 318.

As illustrated in the middle section of FIG. 4, in the upstream fiber link 421, wavelength bar 431 occupies spectral slots 9-10 in Band A, wavelength bar 432 occupies slots 1-3 in Band A, and wavelength bar 433 occupies slots 5-8 in Band B. In the downstream fiber link 423, wavelength bar 434 occupies a single slot 10 in Band A, wavelength bar 435 occupies slots 2-4 in Band A, and wavelength bar 436 occupies slots 4-8 in Band B.

The bottom section of FIG. 4 illustrates the assignment of spectral slots at the intermediate ROADM node 414. Box 444 represents the intermediate ROADM node 414 and is divided into two columns. Following the same assignment method described for FIG. 3, in the upstream fiber link 421, five available channels are assigned to five virtual nodes in the left column of box 444. For example, Band A Channel ID 6, representing slots 6-8 of Band A, meets the new wavelength demand requiring 3 slots and is therefore assigned to virtual node 451. Similarly, virtual nodes 452-455 in the left column are assigned Band A Channel ID 5, Band A Channel ID 4, Band B Channel ID 2, and Band B Channel ID 1, respectively.

Likewise, there are 4 available channels in the downstream fiber link 423. Using the same assignment method, virtual nodes 456-459 in the right column of box 444 are assigned Band A Channel ID 7, Band A Channel ID 6, Band A Channel ID 5, and Band B Channel ID 1, respectively.

After identifying and assigning the available channels of both upstream and downstream fiber links to their respective virtual nodes, the next step in creating the auxiliary graph is to connect certain virtual nodes in the left column of a physical node to specific virtual nodes in the right column of the physical node to add virtual links. A virtual node in the left column may connect to a virtual node in the right column in following ways. In instances in which a pair of virtual nodes in both columns share matching channel IDs within the same band, i.e., they occupy the same optical band and spectral slots, they may be directly connected without a wavelength converter. For virtual nodes that cannot be directly connected, pairs in different bands may connect through a wavelength converter.

For example, virtual nodes 451 may directly connect to virtual node 457 by adding virtual link 461 without a wavelength converter because they occupy the same Channel ID 6 in the same Band A. Likewise, virtual nodes 452 and 458, and virtual nodes 455 and 459, may also be directly connected by adding virtual links 462 and 463, respectively. Virtual nodes 453 and 454 cannot be directly connected because there are no matching channel IDs within the same bands in the right column. In this case, an alternative connection may be established using one or more wavelength converters via virtual link 464, which represents channel IDs before or after wavelength conversion with band information (Band A or Band B). Finally, additional virtual links 471-479 are added between the virtual nodes of intermediate node 414 and the corresponding virtual nodes of the neighboring physical nodes 412 and 418, as illustrated in FIG. 4.

When converting the wavelengths of an optical signal from one band to another, a wavelength converter may use either a frequency-shifting method or a phase conjugation method. In the frequency-shifting method, the frequencies of channels in the first band are shifted to their corresponding channels in the second band. For example, the first channel of the first band is converted to the first channel of the second band, the second channel to the second, and so forth, with the last channel in the first band mapped to the last channel in the second band. On the contrary, the phase conjugation method reverses this order. The first slot of the first band is converted to the last slot in the second band, the second slot to the second-to-last slot, continuing this pattern until the last slot of the first band is mapped to the first slot of the last band. In this example, slots 2, 3, and 4 in Band B of fiber link 421, denoted as Band B channel ID 2 at virtual node 454, may be converted to slots 9, 8, and 7 in Band A of fiber link 423, denoted as Band A channel ID 7 at virtual node 456, through a wavelength converter using optical phase conjugation via virtual link 464.

Accordingly, at intermediate node 414, four connections are formed between virtual nodes in the left and the right columns by adding virtual links 461-464, representing four spectral paths that passthrough the node. This process of connecting virtual nodes across the left and right columns may also be applied to the source and destination nodes. Virtual nodes at source or destination node represents, or are bound to, spectral slots that are assigned to the transponder of the physical node. For example, referring back to FIG. 3, assuming virtual source node 351 is a C-band transponder, and Band A in the first fiber link 321 represents a C-band while Band B represents an S-band, the virtual link 361 connecting virtual source node 351 and virtual node 355 may not include a wavelength converter because the two virtual nodes share the same band. However, the virtual link 363 connecting virtual nodes 351 and 354 may include a wavelength converter because they operate in different bands. Similarly, in instances in which virtual destination node 359 operates in a different transmission band than any of virtual nodes 356-358, the virtual links connecting to those nodes may also include a wavelength converter. The virtual nodes between different physical nodes are connected via additional virtual links 371-377 in FIG. 3 or virtual links 471-479 in FIG. 4. In those instances, virtual links represent channels in fiber links.

To construct the complete auxiliary graph, this process of connecting virtual nodes across two columns may be applied iteratively across all physical nodes from the source node to the destination node. Depending on the configurations of each node and fiber link, multiple spectral paths may be identified in the auxiliary graph. After the spectral paths are identified as candidates, the cost of each candidate path may be calculated. Based on the cost assessment, certain candidate paths may be pruned or eliminated to find an optimal path with the minimum GSNR margin and the lowest overall cost.

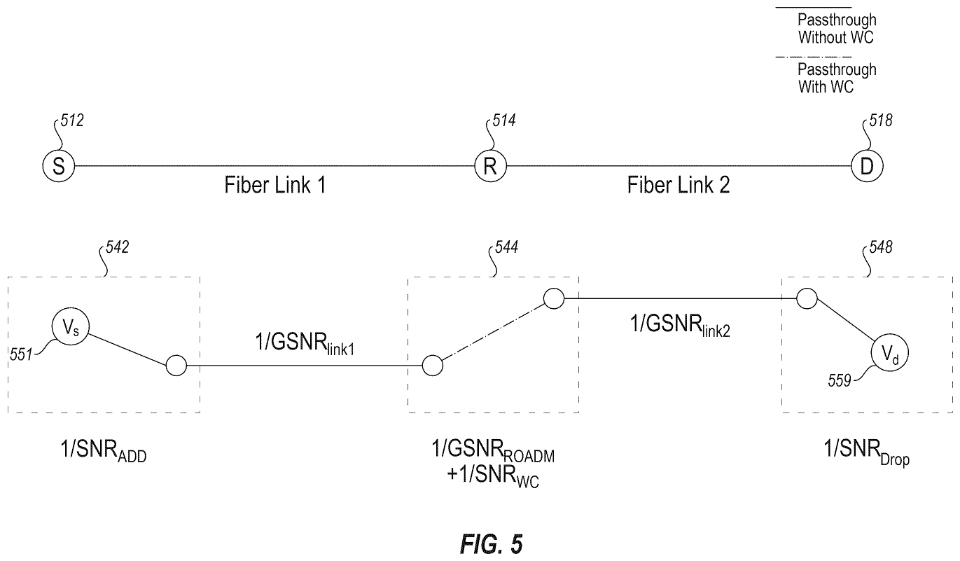

FIG. 5 illustrates the calculation of costs for different segments within a spectral path, according to at least one embodiment described in the present disclosure. The top section of FIG. 5 illustrates an established optical path from source node 512 to destination node 518, passing through an intermediate ROADM node 514. The bottom section of FIG. 5 illustrates a spectral path found among multiple candidate spectral paths in the auxiliary graph, determined using the spectral path assignment process that are further described in detail below. Boxes 542, 544, and 548 represent source node 512, intermediate node 514, and destination node 518, respectively. The three physical nodes are interconnected by fiber link 1 and fiber link 2. In this example, the spectral path contains one intermediate node 514 and one wavelength converter (WC). In other examples, a spectral path may include different numbers of intermediate nodes and wavelength converters.

The total cost of the spectral path, which extends from virtual source node 551 to virtual destination node 559, is calculated as the sum of the costs of virtual links along the path. In this example, the cost of virtual links at the source and the destination nodes may be expressed as 1/SNR_{Add} and 1/SNR_{Drop}, respectively. The cost of virtual links corresponding to each fiber link may be expressed as 1/GSNRₗᵢₙₖ. The cost of intermediate ROADM node 514 is the sum of the cost of the node itself and the cost of the wavelength converter, which may be expressed as 1/GSNR_{ROADM}+1/SNR_{WC}. The GSNR and SNR for virtual link cost are precalculated based on channel ID, optical signal bandwidth, modulation format, optical power, optical fiber link, optical components in nodes, or actual amplifier configurations considering wavelength converters. Thus, the total cost of the entire spectral path may be formulated by the following expression (1):

$$Cost = 1 / S N {R}_{A d d} + 1 / G S N {R}_{l i n k 1} + 1 / G S N {R}_{R O A D M} + 1 / S N {R}_{W C} + 1 / GSN {R}_{l i n k 2} + 1 / S N {R}_{D r o p} \qquad ( 1 )$$

The reciprocal of cost (1/Cost) is the GSNR_{transmitted} of transmitted optical signal of a wavelength when the spectral slots are assigned corresponding the spectral path in FIG. 5 for the wavelength.

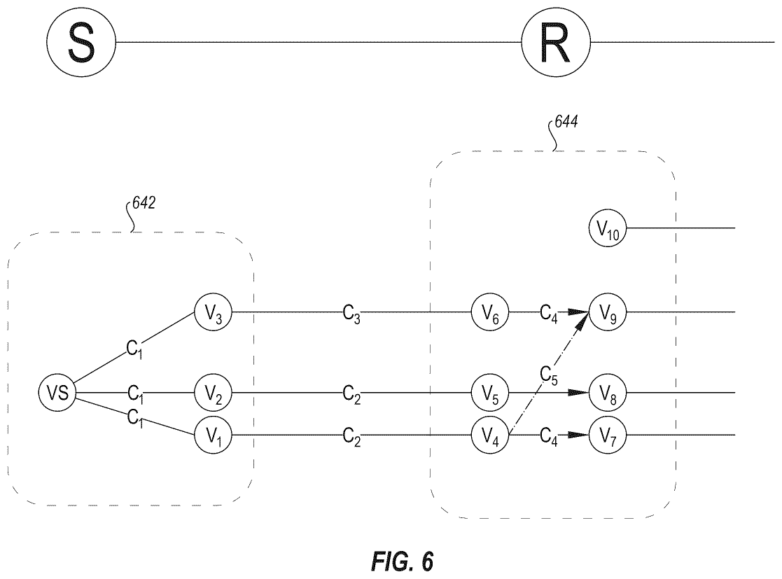

FIG. 6 illustrates an example of assessing the costs associated with candidate spectral paths, according to at least one embodiment described in the present disclosure. As in FIGS. 3 and 4, the top section of FIG. 6 illustrates a source node and a ROADM node in an established optical path. The bottom section of FIG. 6 illustrates the corresponding virtual nodes arranged in two columns within boxes 642 and 644, representing the source and ROADM nodes, respectively. Various connections link the virtual nodes from one column to the next, with each virtual link cost indicated by labels C1 through C5, as illustrated.

After the auxiliary graph is constructed, a network controller traverses all the virtual nodes, beginning at the virtual source node, to build a list of candidate spectral paths and assess the cost of each path. The network controller first initializes all virtual node cost to infinity, except for the virtual source node vₛ, which is set as zero. Starting from vₛ, the network controller lists all possible paths leading to the virtual nodes in the next column. For each reachable virtual node, the controller updates the cumulative cost from the source node along the traveled path. Some virtual nodes may not be reachable in the instances in which they have infinite cost. Among the candidate paths that reach the virtual destination node v_{d} (not illustrated in the figure), the paths with the least GSNR margin with respect to the required GSNR threshold (RGSNR_{threshold}) will be selected.

The number of candidate path list will grow fast while traveling toward virtual destination node v_{d}. Some candidate paths will be eliminated at each ROADM node (or column of virtual nodes in auxiliary graph) to reduce the number of candidate paths based on the possible range of GSNR_{transmitted}, number of wavelength converters, and wavelength cost.

While the network controller iterates through virtual nodes in the auxiliary graph, candidate paths may be removed based on the accumulated GSNR at each traveled (or iterated) virtual node, the RGSNR_{threshold} at the virtual destination node, and the expected GSNR range of the transmitted signal (GSNR_{transmitted}). The accumulated GSNR (or cost) of the path is calculated from the virtual source node to the virtual node being iterated. The expected GSNR_{transmitted} range (or cost) is calculated between the virtual source node and the virtual destination node via the virtual node under evaluation. The removal of candidate paths is performed by comparing the paths that pass through other virtual nodes in the same column as the traveled node. Furthermore, wavelength cost may be considered to mitigate spectral fragmentation by using a first-or-last-fit first spectral slot assignment in response to multiple candidate path lists having the same GSNR_{transmitted}. The wavelength converter count also may be considered to prefer a smaller number of wavelength converters for the same GSNR at a traveled virtual node. For example, the wavelength converter may convert a first-fit spectral slot in one band to the last-fit spectral slot in another band using phase conjugation. Thus, it may be beneficial to assign a lower wavelength cost to the first and last spectral slots in a band.

For example, in instances in which a wavelength converter is based on phase conjugation, where N_{slot_signal} represents the number of slots required for a chosen modulation format, N_{slot_band} represents the number of slots in a band, then the range of available channel IDs is from 0 to N_{slot_band}−N_{slot_signal}−1, as channel IDs start from zero. Wavelength cost for spectral paths (virtual links) may then be calculated using the following expression (2), which assigns the highest wavelength cost to the middle spectral slots in a band, and the lowest wavelength (WL) cost to the first or last available spectral slots in a band:

$$Wavelength cost = ceil ( \frac{{N}_{slot \_ band} - {N}_{slot \_ signal}}{2} ) - \vert \frac{{N}_{slot \_ band} - {N}_{slot \_ signal}}{2} - channel\_ID \vert \qquad ( 2 )$$

For another example, in instances in which a wavelength converter is based on frequency shifting, then wavelength cost may be calculated using the following expression (3), because wavelength converter does not change channel IDs in the converted band.

$$Wavelength cost = channel\_ID \qquad ( 3 )$$

A weighting factor W_{wc} for wavelength converter cost may also introduced into the wavelength cost calculation. For example, in instances in which a virtual link in auxiliary graph includes a wavelength converter, then an additional cost of W_{wc}×(number of wavelength converters) may be added to the wavelength cost. To prioritize paths with fewer wavelength converters, W_{wc} may be set to a value higher than (number of hops)×(highest wavelength cost of a virtual link). In instances in which the number of wavelength converters is not considered as factor, W_{wc} may be set to zero.

The network controller then pre-calculates the least and greatest costs from any virtual node to the virtual destination node using a smaller number of wavelength converters. The number of wavelength converters, denoted by nWC, is in the range of [0, 1, 2, . . . , n_max_WC]. The range of wavelength cost of a candidate path is determined from the least cost to the greatest cost of that path. The wavelength cost range from a virtual node to v_{d} may also pre-calculated.

For example, in instances in which no available paths exist from a virtual node vₙ to the destination node v_{d} without using a wavelength converter, then least_cost [vₙ, v_{d}, nWC=0]=infinity. In instances in which least_cost [vₙ, v_{d}, nWC=1]=0.1 and least_cost [vₙ, v_{d}, nWC=2]=0.2, then for paths requiring up to one wavelength converter, least_cost [vₙ, v_{d}, nWC<=1]=0.1. For paths requiring up to two wavelength converters, least_cost [vₙ, v_{d}, nW<=2]=0.1 (not 0.2).

This pre-calculation process may include values such as:

$$least\_cost [ {v}_{n} , {v}_{d} , nWC = 0 ]$$

$$least\_cost [ {v}_{n} , {v}_{d} , nWC <= 1 ]$$

$$, …$$

$$least\_cost [ {v}_{n} , {v}_{d} , nWC <= n\_max \_WC ]$$

$$greatest\_cost [ {v}_{n} , {v}_{d} , nWC = 0 ] ,$$

$$greatest\_cost [ {v}_{n} , {v}_{d} , nWC <= 1 ]$$

$$, …$$

$$greatest\_cost [ {v}_{n} , {v}_{d} , nWC <= n\_max \_WC ]$$

In addition, wavelength costs may be calculated for a candidate path between a virtual node vₙ and v_{d} with the least cost GSNR for the allowed number of wavelength converters, which ranges from 0 to n_max_WC.

To assess the cost of candidate paths, the network controller begins at the virtual source node vₛ in the auxiliary graph, listing all possible paths leading to the virtual nodes in the next column of vₛ. The network controller then travels to this next column, iterating through each virtual node of the next column one by one. At each iterated virtual node, the network controller updates the cumulative cost from vₛ. This process continues until the network controller reaches the last column in the auxiliary graph, corresponding to the virtual destination node v_{d}. Some virtual nodes may not be reachable in instances in which they are connected by virtual links with infinite cost. The number of wavelength converters is also counted based on the virtual links that include wavelength converters on the traveled path and their associated wavelength costs.

For example, in FIG. 6, when the network controller iterates at virtual node V₉, it calculates the costs of the path from two previous nodes, V₄ and V₆. For the path from V₄, since the path includes a wavelength converter, the cost is calculated as c₁+c₂+c₅. The number of wavelength converters is 1. The wavelength cost for this path is the sum of wavelength cost of V₁ and wavelength converter cost between V₄ and V₉. For the path from V₆, the cost is c₁+c₂+c₄. Since there is no wavelength converter in this path, the wavelength cost of the path is just the wavelength cost of V₃.

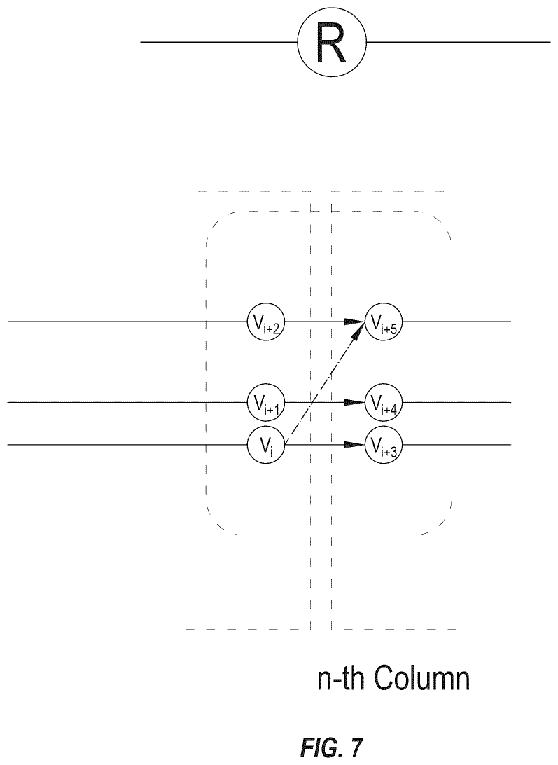

FIG. 7 illustrates an example of assessing various costs of candidate spectral paths at an intermediate node, according to at least one embodiment described in the present disclosure. Similar to FIG. 6, the top section of FIG. 7 illustrates an intermediate ROADM node in an established optical path. The bottom section of FIG. 7 illustrates the corresponding virtual nodes arranged in two columns in the ROADM node. The connection between Vᵢ and Vᵢ₊₅ includes a wavelength converter.

As the network controller iterates through the virtual nodes along the candidate spectral paths and calculate the cost of each path, the maximum number of wavelength converters allowed in the path may also be considered. For example, in instances in which the maximum allowed wavelength converters (WCₘₐₓ) at the destination node is limited to 4, then at virtual node Vᵢ₊₅, the number of wavelength converters may be used (nWC) may vary depending on the cost of the path being calculated. When calculating the cost for the path from Vᵢ₊₂, since no wavelength converter is involved in the path, nWC is still 4. However, for the path from Vᵢ, since there is already one wavelength converter, nWC is 3.

The range of GSNR_{transmitted} to destination v_{d} from an intermediate node vₖ may be estimated when the cost and the number of wavelength converters for a given path to vₖ are known (based on the path list at vₖ). For example, assuming that the number of wavelength converters of path list m at vₖ is 2, the cost range for path m, which is the range between the minimum and maximum GSNR of the path, may be calculated in the following expressions (3) and (4):

$$Max {GSNR}_{transmitted} to {v}_{d} = 1 / \{ cost ( {v}_{k} , path\_list \_m ) + min\_cost [ {v}_{k} , {v}_{d} , nWC <= WC max - 2 ] \} \qquad ( 3 )$$

$$Min {GSNR}_{transmitted} to {v}_{n} = 1 / \{ cost ( {v}_{k} , path\_list \_m ) + max\_cost [ {v}_{k} , {v}_{d} , nWC <= WC max - 2 ] \} \qquad ( 4 )$$

In addition, in instances in which nWC<=WCmax−2, expected wavelength cost for the minimum GSNR may be calculated by adding the wavelength cost up to vₖ and the pre-calculated wavelength cost from vₖ to v_{d}.

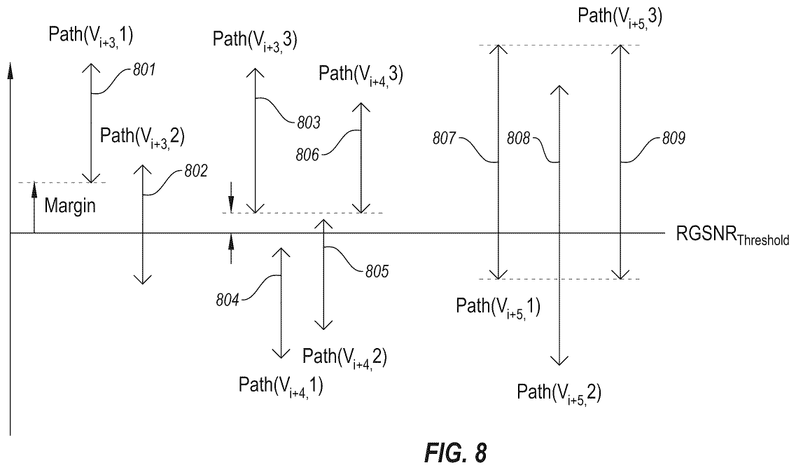

FIG. 8 illustrates a pruning process for candidate spectral paths based on their cost ranges and additional factors, according to at least one embodiment described in the present disclosure. After the network controller completes its iteration of all the virtual nodes in one column (e.g., the n^{th} column), cost ranges for each candidate path are calculated and illustrated in the figure. The vertical axis represents the calculated GSNR_{transmitted} that is the reciprocal of path costs for each candidate path. The horizontal line indicates the required GSNR threshold (RGSNR_{threshold}) for a communication request. In this example, assume there are three virtual nodes Vᵢ₊₃, Vᵢ₊₄, and Vᵢ₊₅ in the column, and each node is associated with three candidate paths, this results in a total of nine candidate paths in this column. The expected range of GSNR_{transmitted} of candidate paths are represented by double-headed arrows 801-809. Each double-headed arrow represents the GSNR range calculated for the candidate path, expressed in the format of Path (V_{node_ID}, path_list_id). For example, Path(Vᵢ₊₃, 1) represents the calculated GSNR_{transmitted} range for Vᵢ₊₃, path list 1.

The goal of the pruning process at the n^{th} column may be to remove as many candidate paths as possible based on their calculated range of GSNR_{transmitted}. The range of GSNR_{transmitted} of candidate paths fall into three categories. The first category includes paths with the GSNR ranges entirely below the required GSNR threshold. Since these paths do not meet the minimum wavelength requirement, they should therefore be removed. For example, arrow 804 falls entirely below RGSNR_{threshold}. Accordingly, Path (Vᵢ₊₄, 1) is removed.

The second category includes paths with the GSNR ranges entirely above the required GSNR threshold. These paths are evaluated based on their GSNR margin and wavelength cost. First, the path with a larger GSNR margin is removed. For example, arrows 801, 803, and 806 fall into this category. Since arrow 801 has a larger GSNR margin than 803 and 806, it is pruned first, corresponding to the removal of Path (Vᵢ₊₃, 1). Second, in instances in which two paths have the same GSNR margin, the path with a higher expected wavelength cost at v_{d} is removed. In this example, between the two arrows 803 and 806 that have the same GSNR margin, arrow 806 is removed because Vᵢ₊₄ corresponds to a higher spectral ID than Vᵢ₊₃. This is because channels with lower slot IDs have lower wavelength costs.

The third category may include those paths crossing the required GSNR threshold, represented by arrows intersecting the threshold line, such as arrows 802, 805, 807, 808, and 809. These paths are evaluated based on their GSNR range and wavelength cost. In instances in which two paths have the same GSNR range, indicated in the figure as two arrows having equal lengths, such as arrows 807 and 809, the path with higher wavelength cost is removed. For example, a path that involves more wavelength converters is removed because it has a higher cost. However, in instances in which the two paths have the same wavelength cost, then one of them may be randomly selected and removed. This is because they both have the same performance. By randomly removing one, the number of candidates may be reduced in the path search.

In one embodiment, GSNR margin is not considered in the pruning process. Instead of pruning spectral paths based on their GSNR margins, a candidate path with the lowest wavelength cost may be selected among reachable paths in the auxiliary graph. This may be achieved by not performing the first step (removing the path with a larger GSNR margin) in the secondary category described above.

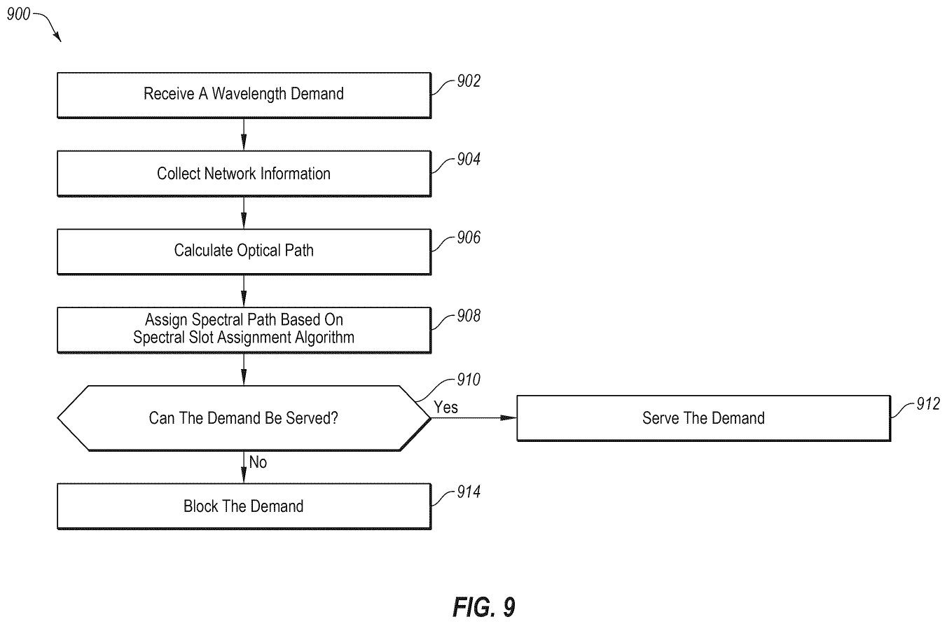

FIG. 9 is a flowchart of an example method 900 for processing a wavelength demand in an optical network, according to at least one embodiment described in the present disclosure. The method 900 may be performed by any suitable system, apparatus, or device such as control plane computing systems or network controllers. By way of example, the module 100 of FIG. 1 and/or the computing system 202 of FIG. 2 (e.g., as included in a network controller) may perform one or more of the operations associated with the method 900. Although illustrated with discrete blocks, the steps and operations associated with one or more of the blocks of the method 900 may be divided into additional blocks, combined into fewer blocks, or eliminated, depending on the particular implementation.

At block 902, a wavelength demand generated by a network device may be received that initiates a new traffic transmission in an optical network. The wavelength demand may include a required GSNR threshold of transmission and a required number of spectral slots of optical signal.

At block 904, information about the optical network may be collected. The network information may include details about the physical nodes, fiber links connecting the physical nodes, supported optical bands, and the distribution of available spectral slots, etc.

At block 906, an optical path may be calculated. Based on the collected network information, an optical path may be chosen using network path routing algorithms such as minimum distance or kth-shortest path.

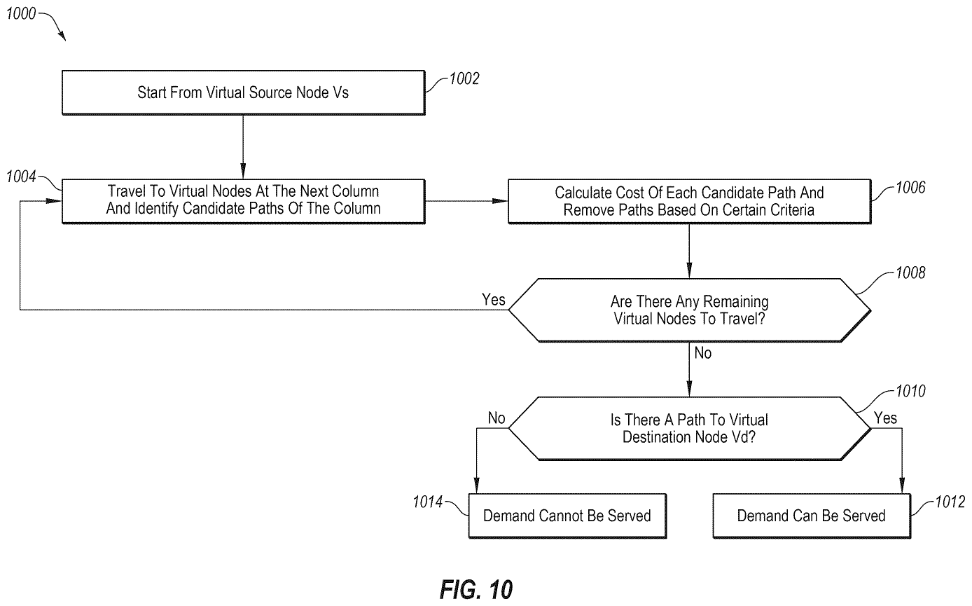

At block 908, depending on the available transmission bands and spectral capacities of the physical nodes and fiber links, an auxiliary graph may be constructed and spectral paths in the optical path may be assigned based on the Spectral Slot Assignment Algorithm, which is further illustrated in FIG. 10.

At block 910, using the Spectral Slot Assignment Algorithm results, a determination may be made regarding whether the wavelength demand can be served. In instances in which the demand may be served, the demand may be served at block 912. In one example, the demand may be served by assigning a wavelength to the chosen spectral path such as assigning spectral slots and network resources. Otherwise, the demand may be blocked at block 914.

FIG. 10 is a flowchart of an example method 1000 for assigning spectral slots in an auxiliary graph, according to at least one embodiment described in the present disclosure. The method 1000 may be performed by any suitable system, apparatus, or device such as the module 100 of FIG. 1 (e.g., as implemented in control plane computing systems or network controllers). Additionally or alternatively, the computing system 202 of FIG. 2 may perform one or more of the operations associated with the method 1000. Although illustrated with discrete blocks, the steps and operations associated with one or more of the blocks of the method 1000 may be divided into additional blocks, combined into fewer blocks, or eliminated, depending on the particular implementation.

At block 1002, virtual nodes in an established auxiliary graph may be iterated starting from the virtual source node vₛ.

At block 1004, virtual nodes at the next column connected via virtual links may be travelled to and candidate paths of the column may be identified. For each travelled virtual node, available spectral slots in both upstream and downstream fiber links may be identified. A list of available spectral paths may then be formed by connecting virtual nodes between adjacent columns. This process is further described in FIGS. 3 and 4.

At block 1006, cost of each candidate path may be calculated and paths may be removed based on certain criteria. Calculating cost of a spectral path involves calculating costs for different segments of the path. Factors such as the number of wavelength converts, wavelength cost, etc., may also be considered. The calculation process is further described in FIGS. 5-7. After the cost ranges associated with each candidate path is calculated, the candidate paths may be pruned based on specific criteria, as further described in FIG. 8.

At 1008, a determination may be made regarding whether there are any remaining virtual nodes to travel in the auxiliary graph. In instances in which virtual nodes remain, the process returns to block 1004 for further iteration. In instances in which no virtual nodes remain, the process proceeds to block 1010 to determine whether a path exists to virtual destination node v_{d}. In instances in which at least one path exists, the wavelength demand is served at block 1012. Otherwise, the demand is blocked at block 1014.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. Further, although much of description is given in the context of operations performed by a network controller, any suitable component may be used to perform one or more of the operations described herein.

As indicated above, the embodiments described in the present disclosure may include the use of a special purpose or general purpose computer (e.g., the processor 250 of FIG. 2) including various computer hardware or software modules, as discussed in greater detail below. Further, as indicated above, embodiments described in the present disclosure may be implemented using computer-readable media (e.g., the memory 252 or data storage 254 of FIG. 2) for carrying or having computer-executable instructions or data structures stored thereon.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method for assigning spectral slots in an optical network, the method comprising:
receiving a wavelength demand for transmitting optical signals in required wavelength ranges;
identifying an optical path that includes a plurality of nodes, each node of the plurality of nodes respectively including a plurality of available spectral slots for propagation of the optical signals in respective corresponding wavelength ranges;
for each individual node of the plurality of nodes:
grouping one or more first virtual nodes that respectively correspond to a virtual source node or individual potential incoming spectral slots of the individual node into a first group;
grouping one or more second virtual nodes that respectively correspond to a virtual destination node or individual outgoing spectral slots of the individual node into a second group;
identifying a plurality of spectral paths of the optical path, the plurality of spectral paths individually being related to propagation of the optical signals in one or more spectral slots associated therewith, each spectral path of the plurality of spectral paths passing through one of a plurality of virtual nodes in each first group and each second group of each individual node;
iterating each respective virtual node along the plurality of spectral paths to identify a list of candidate spectral paths in the plurality of spectral paths for each virtual node, each candidate spectral path of each respective virtual node connecting the respective virtual node being iterated to a virtual node corresponding to a next group of virtual nodes along the optical path, the iterating of the respective virtual nodes including pruning one or more candidate spectral paths based on one or more GSNR (Generalized Signal to Noise Ratio) factors; and
serving the wavelength demand when all virtual nodes are iterated and at least one spectral path of the plurality of spectral paths remains after iteration.

2. The method of claim 1, further comprising:
blocking the wavelength demand when no path of the plurality of spectral paths remains during or after iteration.

3. The method of claim 1, further comprising:
collecting information of the optical network including distribution of the available spectral slots in the optical network, supported optical bands, available wavelength converters, available transponders, or a plurality of intermediate nodes.

4. The method of claim 1, wherein the plurality of nodes comprises a source node, a destination node, and a plurality of intermediate nodes, the method further comprising:
calculating the optical path from the source node to the destination node passing through one or more of the plurality of intermediate nodes.

5. The method of claim 1, wherein identifying of the plurality of spectral paths comprises:
connecting a first virtual node in a first group to a second virtual node in the next group without a wavelength converter in response to the first virtual node and the second virtual node occupying a same optical band and spectral slots; and
connecting the first virtual node in the first group to the second virtual node in the next group using a wavelength converter in response to the first virtual node and the second virtual node occupying different optical bands but same spectral slots.

6. The method of claim 1, wherein pruning one or more candidate spectral paths based on one or more GSNR factors comprises:
for each path in the identified list of candidate spectral paths:
calculating a cost range of the path and a GSNR margin of the path, and
removing the path based on one of the cost range of the path and the GSNR margin of the path.

7. The method of claim 6, wherein the cost range of the path is a summation of accumulated cost of the path and expected cost range of the path,
wherein the accumulated cost of the path is calculated from the virtual source node to the virtual node being iterated, and
wherein the expected cost range of the path is calculated from the virtual node being iterated to the virtual destination node.

8. The method of claim 7, wherein the accumulated cost of the path is the summation of:
cost of a set of virtual nodes accumulated from the virtual source node to the virtual node being iterated, and
cost of each virtual link connecting the set of virtual nodes.

9. The method of claim 8, wherein the cost of each virtual link is calculated based on at least one of: identification of channel, optical signal bandwidth, modulation format, optical power, optical fiber link, optical components in nodes, and actual amplifier configurations based on wavelength converters.

10. The method of claim 6, wherein calculating the GSNR margin of the path comprises calculating a margin of a lowest GSNR in the cost range of the path that is greater than a required GSNR threshold.

11. The method of claim 6, wherein removing the path based on one of the cost range of the path and the GSNR margin of the path comprises:
removing the path in instances in which the GSNR margin of the path is not the lowest among the paths in the identified list of candidate spectral paths.

12. The method of claim 6, wherein removing the path based on one of the cost range of the path and the GSNR margin of the path comprises:
in instances in which two paths in the identified list of candidate spectral paths have the same GSNR margins:
calculating wavelength cost for each path of the two paths; and
removing a path in the two paths that has a higher wavelength cost.

13. The method of claim 12, wherein the plurality of spectral path comprise one or more wavelength converters, and wherein the wavelength cost of the path is a summation of wavelength cost of each virtual node in the path and wavelength converter cost of each wavelength converter in the path.

14. The method of claim 12, wherein the wavelength cost of the path is a range between a least wavelength cost of the path and a greatest wavelength cost of the path calculated based on wavelength cost of each virtual node in the path and a maximum allowed number of wavelength converters in the path.

15. The method of claim 6, wherein removing the path based on one of the cost range of the path and the GSNR margin of the path comprises:
calculating wavelength cost for each path of the identified list of candidate spectral paths;
identifying the lowest wavelength cost for the identified list of candidate spectral paths; and
removing one or more paths in the identified list of candidate spectral paths that do not have the lowest wavelength cost.

16. A computing system comprising:
one or more processors; and
one or more non-transitory computer-readable storage media configured to store instructions that, in response to being executed by the one or more processors, cause the computing system to perform operations, the operations comprising:
receiving a wavelength demand for transmitting optical signals in required wavelength ranges;
identifying an optical path that includes a plurality of nodes, each node of the plurality of nodes respectively including a plurality of available spectral slots for propagation of the optical signals in respective corresponding wavelength ranges;
for each individual node of the plurality of nodes:
grouping a plurality of first virtual nodes that respectively correspond to individual potential incoming spectral slots of the individual node into a first group;
grouping a plurality of second virtual nodes that respectively correspond to individual outgoing spectral slots of the individual node into a second group;
identifying a plurality of spectral paths of the optical path, the plurality of spectral paths individually being related to propagation of the optical signals in one or more spectral slots associated therewith, each spectral path of the plurality of spectral paths passing through one of the plurality of virtual nodes in each first group and each second group of each individual node;
iterating each respective virtual node along the plurality of spectral paths to identify a list of candidate spectral paths in the plurality of spectral paths for each virtual node, each candidate spectral path of each respective virtual node connecting the respective virtual node being iterated to a virtual node corresponding to a next group of virtual nodes along the optical path, the iterating of the respective virtual nodes including pruning one or more candidate spectral paths based on one or more GSNR (Generalized Signal to Noise Ratio) factors; and
serving the wavelength demand when all virtual nodes are iterated and at least one spectral path of the plurality of spectral paths remains after iteration.
